(19) United States
(12) Patent Application Publication
(10) Pub. No.: US 2026/0075429 A1
(43) Pub. Date: Mar. 12, 2026

(54) RADIO FREQUENCY FINGERPRINTING METHOD AND SYSTEM BASED ON CONVOLUTION-ATTENTION MECHANISM AND MULTI-PACKET INFERENCE

(71) Applicant: SHANDONG UNIVERSITY, Jinan (CN)

(72) Inventors: Chuanting Zhang, Jinan (CN); Jingping Qiao, Jinan (CN); Haixia Zhang, Jinan (CN); Xin Li, Jinan (CN); Yueheng Li, Jinan (CN)

(73) Assignee: SHANDONG UNIVERSITY, Jinan (CN)

(21) Appl. No.: 19/395,083

(22) Filed: Nov. 20, 2025

(30) Foreign Application Priority Data
Jun. 19, 2025 (CN) 202510820264X

(51) Int. Cl. H04W 12/79; H04L 41/147; H04L 41/16

(52) U.S. Cl. CPC H04W 12/79; H04L 41/147; H04L 41/16

(57) ABSTRACT

A radio frequency fingerprinting method and system based on a convolution-attention mechanism and multi-packet inference are disclosed, and belong to the technical field of communication networks and artificial intelligence. The radio frequency fingerprinting method based on the convolution-attention mechanism and multi-packet inference includes: step 1: capturing a device transmission signal, and preprocessing the transmission signal to obtain a spectrogram; step 2: constructing a radio frequency fingerprinting model, and inputting the obtained spectrogram into the radio frequency fingerprinting model for training, to obtain a trained radio frequency fingerprinting model; and step 3: performing prediction by employing the trained radio frequency fingerprinting model, to obtain a final prediction result.

### CROSS-REFERENCE TO RELATED APPLICATIONS

This application claims priority to Chinese Patent Application Ser. No. CN202510820264X filed on 19 Jun. 2025.

### FIELD OF THE INVENTION

The present disclosure relates to a radio frequency fingerprinting method and system based on a convolution-attention mechanism and multi-packet inference, which belongs to the technical field of communication networks and artificial intelligence.

### BACKGROUND OF THE INVENTION

Radio frequency fingerprinting (RFF) is a critical technology for device authentication and security guarantee in wireless communication systems; by extracting unique features generated in a signal transmission process of a wireless device, the RFF can effectively identify device identities; and traditional radio frequency fingerprinting methods generally rely on specific feature engineering and classifiers based on a statistical method. However, these methods often exhibit low robustness and classification accuracy when faced with complex channel conditions, signal noise interference, and similarity between devices. In recent years, with the advancement of deep learning technologies, deep learning-based radio frequency fingerprinting models have gradually become mainstream. These models can automatically extract time-frequency domain features from signals and significantly improve the device classification accuracy.

Currently, the application of deep learning models in the field of radio frequency fingerprinting primarily focuses on classical structures such as convolutional neural networks (CNN) and long short-term memory (LSTM). However, single-model methods may face limitations when processing complex signal features. For example, the CNN is excellent at capturing local features, but lacks modeling capability for global temporal sequence information; and a recirculating network such as the LSTM can capture long dependence of time series, but has low computation efficiency and difficulties in processing high-dimensional signal data.

For the aforementioned problems, a Transformer has gradually become a research hotspot for processing a sequence signal due to powerful global feature modeling capability and parallel computation efficiency. However, directly applying the Transformer to radio frequency fingerprinting still faces several challenges. For example, the locality of signal features may not be fully utilized, and the global modeling capability may be constrained by the expression capability of the inputted features. To solve these problems, there is an urgent need for a radio frequency fingerprinting method capable of simultaneously capturing both local features and global dependence of signals, to enhance the classification accuracy and robustness against noise data of the model.

### SUMMARY OF THE INVENTION

For disadvantages in the prior art, the present disclosure provides a radio frequency fingerprinting method and system based on a convolution-attention mechanism and multi-packet inference, to solve the problems of traditional radio frequency fingerprinting models such as performance degradation in noise environments, insufficient feature extraction, and difficulty for balancing global and local features with a single model for complex data. The present disclosure provides a deep learning model architecture (RFF-CAT) integrating a convolutional neural network (CNN) and a Transformer encoder by further analyzing local and global feature distribution rule of a radio frequency signal. The model utilizes a convolutional layer to enhance a local feature extraction capability, to extract local features from an original radio frequency signal, and effectively eliminate noise and preserve key signal features through layered convolutional operations; and at the same time, a Transformer encoder module captures a global dependence of the radio frequency signal through a multi-head self-attention mechanism and enhances a sequence modeling capability by integrating explicit positional encoding.

In terms of module design, to solve the problems of high computation complexity and redundant module interactions in a traditional model fusion mechanism, the present disclosure adopts a module separation strategy, which enables independent optimization of a convolutional module and a Transformer module, thereby reducing the computation complexity, and enhancing model stability. To further enhance the accuracy of the model, the present disclosure further introduces an adaptive multi-packet fusion (MPF) method; and the method improves identification performance in a low signal-to-noise ratio (SNR) environment by dividing data into multiple packets and performing weighted fusion on different packets in a weighted summation manner.

The present disclosure adopts a technical solution as follows:

According to a first aspect of the present disclosure, provided is a radio frequency fingerprinting method based on a convolution-attention mechanism and multi-packet inference, which includes:
Step 1: capturing a device transmission signal, and preprocessing the transmission signal to obtain a spectrogram;
Step 2: constructing a radio frequency fingerprinting model, and inputting the obtained spectrogram into the radio frequency fingerprinting model for training, to obtain a trained radio frequency fingerprinting model, where
the radio frequency fingerprinting model includes a convolutional layer, a positional encoding layer, and a Transformer encoder;
the convolutional layer transforms an inputted feature map into a high-order feature representation;
the positional encoding layer is configured to add position information (an absolute position or a relative position), enabling the model to have a sequence information processing capability;
the Transformer encoder includes a multi-head self-attention mechanism and a feed-forward neural network layer (FFN), the multi-head self-attention mechanism is used for capturing global dependencies that span an entire sequence, and the feed-forward neural network layer further enhances a feature expression capability; and
Step 3: performing prediction by employing the trained radio frequency fingerprinting model, to obtain a final prediction result by incorporating a multi-packet inference method, thereby achieving device authentication and identification.

Preferably, the capturing a device transmission signal, and preprocessing the transmission signal to obtain a spectrogram includes:
firstly, acquiring the transmission signal from a long range (LoRa) device, where the signal is denoted as r(n), and the LoRa device employs a LoRa protocol;
secondly, calculating a carrier frequency offset (CFO), as shown in the following formula:

$$Δ f = \frac{1}{2 π} \frac{d}{dt} arg ( r ( n ) ) ,$$

where arg(⋅) denotes a phase of the transmission signal, n denotes a time variable, and Δf denotes the carrier frequency offset;
compensating the carrier frequency offset (CFO) to reduce an error caused by the carrier frequency offset, as shown in the following formula:

$$\hat{r} ( n ) = r ( n ) \cdot {e}^{- j \cdot 2 π \cdot CFO \cdot t} ,$$

where r(n) is a received signal, \hat{r}(n) is a compensated signal, j denotes an imaginary unit, CFO denotes the carrier frequency offset, i.e., Δf, and t denotes the time variable;
normalizing the compensated signal into a unit amplitude by employing data normalization, to eliminate an impact of a transmission power difference among devices on classification, as shown in the following formula:

$${r}_{norm} ( n ) = \frac{r ( n )}{max ( \vert \hat{r} ( n ) \vert ) ,}$$

where rₙₒᵣₘ(n) denotes the normalized received signal with an amplitude limited in a range of [−1, 1], which is configured for unifying energy scales of different device signals, thereby enhancing sensitivity of the model for structural features in device fingerprints, and reducing interference of the transmission power difference on a classification result; and
finally, performing short-time Fourier transform (STFT) to obtain a channel-independent spectrogram, to alleviate an impact of a signal channel, as shown in the following formula:

$$S ( f , t ) = {\sum }_{n = 0}^{N - 1} {r}_{norm} ( n ) \cdot w ( n - t ) \cdot {e}^{- j 2 π fn} ,$$

where S(f, t) denotes the spectrogram, w(n−t) denotes a matrix window with a length of N, which is a sliding window function, and is specifically expressed as a rectangular window function with a length N of 64, a segment of signal is selected for transformation starting from time point n and extending to each moment t, j denotes an imaginary unit, and f denotes a frequency.

Preferably, the constructing a radio frequency fingerprinting model, and inputting the obtained spectrogram into the radio frequency fingerprinting model for training, to obtain a trained radio frequency fingerprinting model includes:
the convolutional layer includes a standardization layer, a point convolutional layer, a GLU activation function layer, a depthwise separable convolutional layer, a batch normalization layer, a Swish activation function layer, a concatenated convolutional layer, and a Dropout layer;
firstly, the obtained spectrogram is inputted into the convolutional layer, to standardize the inputted spectrogram to achieve a mean value of 0 and a variance of 1, thereby enhancing training stability, obtaining more uniformly distributed spectral features, and preserving a standardized output of an original structure; a channel dimension is adjusted by employing 1×1 convolutions through the point convolutional layer, feature information is fused or expanded to obtain a feature map with an adjusted number of channels; key information of the feature map is enhanced through the GLU activation function layer while redundant information of the feature map is suppressed; parameters of the feature map are reduced through the depthwise separable convolutional layer while a spatial feature is enhanced; a feature map with a stable distribution is obtained through the batch normalization layer; an activated feature map is obtained through the Swish activation function layer, while subtle gradient information of a negative value area is preserved; a final feature representation with an optimized number of channels is obtained through the concatenated convolutional layer; a regularized feature map X is obtained through the Dropout layer; and low-level local features such as edges and textures of the spectrogram are extracted by the module from the signal, which contribute to subsequent pattern identification of the signal;
then, the regularized feature map is introduced into the positional encoding layer after being subjected to the operations at the convolutional layer, to obtain a feature map subjected to positional encoding, an output of the convolutional layer is properly adjusted, and a time relationship present in the data is captured, where specifically, positional embedding is added into the output of the convolutional layer, as shown in the following formula:

$$PE ( X ) = X + Embedding ( pos ) ,$$

where PE(X) denotes the feature map subjected to the positional encoding, X is the output of the convolutional layer, Embedding(pos) is the positional encoding, the explicit encoding facilitates the model to understand an order and dependence of the features in a sequence, which is a key factor for time series analysis and signal processing tasks; and
finally, the feature map subjected to the positional encoding is inputted into the Transformer encoder, and the Transformer encoder captures the global dependencies that span the entire sequence by employing the multi-head self-attention mechanism; and
simulates a long-distance relationship between the features, so that the model can understand a context and global mode that is critical for accurate classification, and specifically operations are as follows:

$${head}_{i} = Attention ( {W}_{i}^{Q} {X}_{1} , {W}_{i}^{K} {X}_{1} , {W}_{i}^{V} {X}_{1} ) ;$$

where X₁ denotes an input, i.e., the feature map subjected to the positional encoding, and Wᵢ^{Q} denotes a query matrix of an i^{th} attention head, used for mapping an inputted feature to a query vector; Wᵢ^{K} denotes a key matrix of the i^{th} attention head, used for mapping the inputted feature to a key vector; Wᵢ^{V} denotes a value matrix of the i^{th} attention head, used for mapping the inputted feature to a value vector; and h attention heads generate a final output of the multi-head self-attention mechanism, and the output undergoes concatenation and linear transform, as shown in the following formula:

$$MHA ( {X}_{1} ) = {W}^{O} ( {head}_{1} ‖ … ‖ {head}_{h} )$$

where MHA(X₁) denotes the output of the multi-head self-attention mechanism, and W^{O} is an output weight matrix; a combined output of the multi-head self-attention mechanism is mapped to ensure alignment with a final output dimension of the Transformer model;
the attention mechanism enables the model to selectively focus on important features at different positions in the sequence, thereby more effectively simulating the global context and dependencies; and the feed-forward neural network layer is employed to further complete the feature representation; and
after the processing by the Transformer encoder, a time dimension of the feature map is compressed into a feature vector with a fixed length through a one-dimensional global average pooling layer; finally, the feature vector is fed into a fully connected layer and a Softmax layer for classification, to obtain a trained RFF-CAT model, i.e., the radio frequency fingerprinting model after training, where the design of the RFF-CAT model ensures independent processing of local and global feature extraction; the convolutional layer specializes in capturing the local features, and the Transformer encoder is skilled in simulating the global dependence; by separating the tasks, the model reduces computation complexity, enhances flexibility, and improves performance in the noise environment; and compared with a traditional conformer model (generally integrating CNN and Transformer operations in a single module), the separation also results in a simpler and more interpretable model architecture; and
a training process of the RFF-CAT model includes:
   1) minimizing a cross-entropy loss function by employing a root mean square propagation (RMSProp) optimization algorithm;
   2) performing batch processing on the training data, and executing multiple rounds of iterative training until convergence; and
   3) introducing a learning rate scheduling strategy in the training process to improve the training efficiency.

Preferably, the performing prediction by employing the trained radio frequency fingerprinting model, to obtain a final prediction result by incorporating a multi-packet inference method includes:
first preprocessing and transforming radio frequency signal data from an unknown device into a channel-independent spectrogram at a prediction inference stage, and then inputting the spectrogram into the trained RFF-CAT model, where an output of the Softmax layer in the RFF-CAT model is a probability vector, where each element represents a confidence level associated with one of the known devices, and the probability vector indicates the probability of a data packet belonging to each potential device, thereby achieving accurate and reliable device identification;
processing an output of the RFF-CAT model by the multi-packet inference method, i.e., an adaptive fusion method (MPF), to obtain a final output probability, where the multi-packet inference (MPF) method includes:
dividing the inputted radio frequency signal data into a plurality of data packets, calculating an initial prediction value of each data packet, i.e., obtaining an initial prediction value through the RFF-CAT model, defining an initial weight set, and then performing weighted summation, to obtain a fused prediction probability, as shown in the following formula:

$$p = \frac{1}{N} {\sum }_{n = 1}^{N} {w}_{n} {\hat{p}}_{n} ,$$

where p denotes the fused prediction probability, and [symbol] denotes the prediction probability, i.e., the initial prediction value of an n^{th} data packet; Wₙ denotes a weight of the prediction probability of the n^{th} data packet; and different contributions of different data packets may be quantized through the above formula, and different weights are set for the data packets;
calculating an error between the initial prediction value and the fused prediction probability; and updating the weight to adapt to the prediction value of each data packet by generally following an update rule of an error-balancing algorithm, where at each iteration, the update rule of the weight is as shown in the following formula:

$${w}_{n + 1} = {w}_{n} + μ {e}_{n} {p}_{n} ,$$

where wₙ denotes a weight array of the prediction probability of the data packet with an index of n; Wₙ₊₁ denotes the weight array of the data packet with the index of n after the weight is updated, which is prepared for a next iteration; μ denotes a learning rate, which controls an adjustment amplitude of the weight at each iteration; eₙ denotes the error between the initial prediction probability, i.e., the initial prediction value and the fused probability after weighted summation, which reflects a difference between the initial prediction probability and the prediction probability after the weighted summation; and pₙ is an array, including the initial prediction probabilities of the previous N data packets starting from the index n; and
performing weighted summation again on the prediction value of each data packet by employing the updated weight, to obtain a new fused prediction probability, i.e., identifying the radio frequency fingerprint of the corresponding device, where the model outputs the identity of the device, and further can distinguish different devices based on the uniqueness of the radio frequency signal, thereby achieving device authentication and identification.

A computer device is provided, which includes a memory and a processor, where the memory has a computer program stored therein, and the processor, when executing the computer program, implements the steps of the radio frequency fingerprinting method based on the convolution-attention mechanism and multi-packet inference.

A computer-readable storage medium is provided, which has a computer program stored therein, where the computer program is executed by a processor to implement the steps of the radio frequency fingerprinting method based on the convolution-attention mechanism and multi-packet inference.

According to a second aspect of the present disclosure, provided is a radio frequency fingerprinting system based on a convolution-attention mechanism and multi-packet inference, which includes:
a preprocessing module, configured to capture a device transmission signal, and preprocess the transmission signal to obtain a spectrogram;
a model training module, configured to construct a radio frequency fingerprinting model, and input the obtained spectrogram into the radio frequency fingerprinting model for training, to obtain a trained radio frequency fingerprinting model, where
the radio frequency fingerprinting model includes a convolutional layer, a positional encoding layer, and a Transformer encoder;
the convolutional layer transforms an inputted feature map into a high-order feature representation;
the positional encoding layer is configured to add position information; and
the Transformer encoder includes a multi-head self-attention mechanism and a feed-forward neural network layer, the multi-head self-attention mechanism is used for capturing global dependencies that span an entire sequence, and the feed-forward neural network layer further enhances a feature expression capability; and
a multi-packet inference module, configured to perform prediction by employing the trained radio frequency fingerprinting model, to obtain a final prediction result by incorporating a multi-packet inference method.

### The Present Disclosure has the Beneficial Effects:

1. According to the present disclosure, by modeling the radio frequency fingerprinting as a deep learning problem based on the convolutional layers and the Transformer encoder, and further proposing the adaptive multi-packet fusion method, the feature extraction capability of the convolutional layers and the transformer are combined in the model training process, thereby effectively enhancing the feature expression and classification accuracy of the radio frequency signal.
2. The RFF-CAT model shows higher accuracy, stability, and robustness when processing complex spatio-temporal data and high-dimensional feature maps, and is a deep learning model with broad application prospects. The present disclosure has superior performance in low signal-to-noise ratio (SNR) environments, which can significantly enhance the overall performance of a distributed radio frequency fingerprinting system, and improve the device identification accuracy and robustness.

### BRIEF DESCRIPTION OF THE DRAWINGS

FIG. 1 is a schematic diagram of a radio frequency fingerprinting system model and a flowchart of radio frequency fingerprinting according to the present disclosure;

FIG. 2 is a schematic diagram of an RFF-CAT model according to the present disclosure;

FIG. 3A shows time-domain diagrams of datasets used in experiments of the present disclosure that is a time-domain diagram of a dataset collected from a LoRa device with a spreading factor set to 7;

FIG. 3B shows time-domain diagrams of datasets used in experiments of the present disclosure which is a time-domain diagram of a dataset collected from the LoRa device with the spreading factor set to 8;

FIG. 3C shows time-domain diagrams of datasets used in experiments of the present disclosure which is a time-domain diagram of a dataset collected from the LoRa device with the spreading factor set to 9;

FIG. 4 is a spectrogram generated after preprocessing datasets used in the present disclosure;

FIG. 5 is a diagram showing overall comparison between RFF-CAT and a baseline prediction performance model;

FIG. 6A is a schematic diagram of prediction performance comparison and mean value-based inference of different signal-to-noise ratios under an MPF condition according to the present disclosure that shows accuracy with and without MPF at a signal-to-noise ratio of 0;

FIG. 6B is a schematic diagram of prediction performance comparison and mean value-based inference of different signal-to-noise ratios under an MPF condition according to the present disclosure that shows the accuracy with and without the MPF at a signal-to-noise ratio of 5;

FIG. 6C is a schematic diagram of prediction performance comparison and mean value-based inference of different signal-to-noise ratios under an MPF condition according to the present disclosure that shows the accuracy with and without the MPF at a signal-to-noise ratio of 10;

FIG. 6D is a schematic diagram of prediction performance comparison and mean value-based inference of different signal-to-noise ratios under an MPF condition according to the present disclosure that shows the accuracy with and without the MPF at a signal-to-noise ratio of 20; and

FIG. 7 is a schematic diagram of classification between an MPF method (weighted sum) used in the present disclosure and a conventional method based on a mean value.

### DETAILED DESCRIPTION OF THE EMBODIMENTS

The present disclosure is further described below through embodiments in conjunction with accompanying drawings, but is not limited thereto.

### Embodiment 1

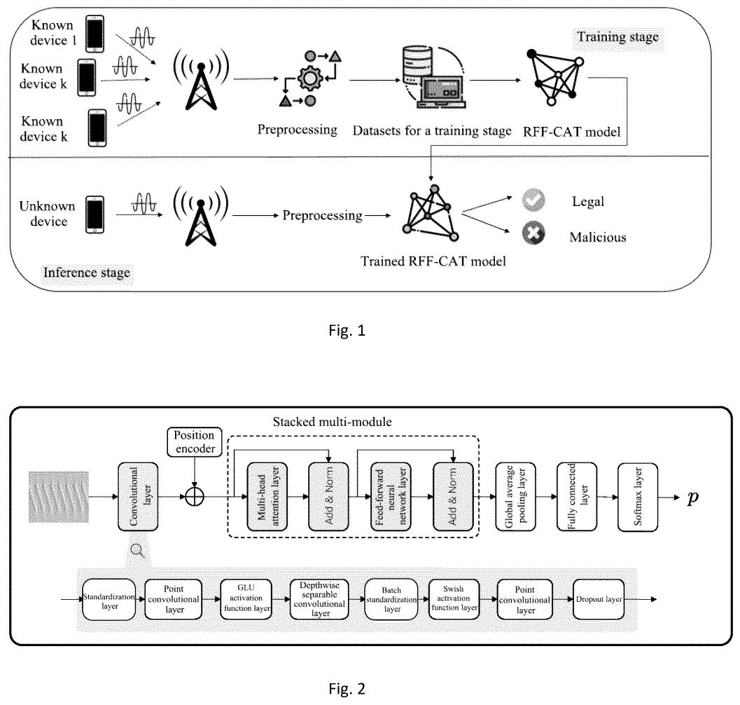

A radio frequency fingerprinting method based on a convolution-attention mechanism and multi-packet inference, as shown in FIG. 1, includes:
Step 1: capture a device transmission signal, and preprocess the transmission signal to obtain a spectrogram;
Step 2: construct a radio frequency fingerprinting model, and input the obtained spectrogram into the radio frequency fingerprinting model for training, to obtain a trained radio frequency fingerprinting model, where
the radio frequency fingerprinting model includes a convolutional layer, a positional encoding layer, and a Transformer encoder;
the convolutional layer transforms an inputted feature map into a high-order feature representation;
the positional encoding layer is configured to add position information (an absolute position or a relative position), enabling the model to have a sequence information processing capability;
the Transformer encoder includes a multi-head self-attention mechanism and a feed-forward neural network layer (FFN), the multi-head self-attention mechanism is used for capturing global dependencies that span an entire sequence, and the feed-forward neural network layer further enhances a feature expression capability; and
Step 3: perform prediction by employing the trained radio frequency fingerprinting model, to obtain a final prediction result by incorporating a multi-packet inference method, thereby achieving device authentication and identification.

### Embodiment 2

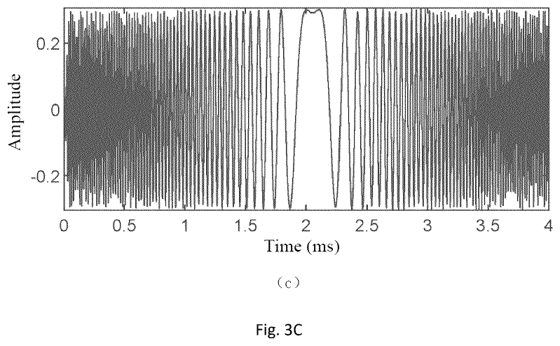

A radio frequency fingerprinting method based on a convolution-attention mechanism and multi-packet inference differs from the method in Embodiment 1 in that:
a device transmission signal is captured, and a time-domain diagram of the transmission signal is as shown in FIG. 3A-C; FIG. 3A is a time-domain diagram of a dataset collected from a long range (LoRa) device with a spreading factor set to 7; FIG. 3B is a time-domain diagram of a dataset collected from the LoRa device with the spreading factor set to 8; and FIG. 3C is a time-domain diagram of a dataset collected from the LoRa device with the spreading factor set to 9; and the transmission signal is preprocessed to obtain a spectrogram, including:
firstly, the transmission signal is acquired from the LoRa device, and denoted as r(n), and the LoRa device employs a LoRa protocol;
the LoRa device refers to a terminal device that utilizes a long range (LoRa) modulation technology for wireless communication; the LoRa devices generally feature low power consumption, long-range connectivity, and low-rate data transmission capability, and are widely applied to Internet of Things (IoT) scenes such as smart metering, environmental monitoring, agricultural IoT, and smart cities; and the LoRa devices include sensor nodes, gateways, modules, etc., and can run for long time without frequent recharging, and are suitable for being deployed in application environments that are sensitive to energy consumption;
the LoRa protocol generally refers to the LoRa wide area network (LoRaWAN) protocol, which is an open low-power-consumption wide-area network (LPWAN) communication protocol built upon a LoRa physical layer technology; and the LoRaWAN adopts a star topology and supports mechanisms such as device classification management, security authentication, and end-to-end encryption, and has advantages such as low power consumption, long-range connectivity, and support for massive device connections, which is particularly suitable for applications requiring remote, intermittent, and small-data-volume transmissions;
secondly, a carrier frequency offset (CFO) is calculated, as shown in the following formula:

$$Δ f = \frac{1}{2 π} \frac{d}{dt} arg ( r ( n ) ) ,$$

where arg(⋅) denotes a phase of the transmission signal, n denotes a time variable, and Δf denotes the carrier frequency offset;
the carrier frequency offset (CFO) is compensated to reduce an error caused by the carrier frequency offset, as shown in the following formula:

$$\hat{r} ( n ) = r ( n ) \cdot {e}^{- j \cdot 2 π \cdot CFO \cdot t} ,$$

where r(n) is a received signal, \hat{r}(n) is a compensated signal, j denotes an imaginary unit, CFO denotes the carrier frequency offset, i.e., Δf, and t denotes the time variable;
the compensated signal is normalized into a unit amplitude by employing data normalization, to eliminate an impact of a transmission power difference among devices on classification, as shown in the following formula:

$${r}_{norm} ( n ) = \frac{r ( n )}{max ( \vert \hat{r} ( n ) \vert ) ,}$$

where rₙₒᵣₘ(n) denotes the normalized received signal with an amplitude limited in a range of [−1, 1], which is configured for unifying energy scales of different device signals, thereby enhancing sensitivity of the model for structural features in device fingerprints, and reducing interference of the transmission power difference on a classification result; and
finally, short-time Fourier transform (STFT) is performed to obtain a channel-independent spectrogram, to alleviate an impact of a signal channel, as shown in the following formula:

$$S ( f , t ) = {\sum }_{n = 0}^{N - 1} {r}_{norm} ( n ) \cdot w ( n - t ) \cdot {e}^{- j 2 π fn} ,$$

where S(f, t) denotes the spectrogram, w(n−t) denotes a matrix window with a length of N, which is a sliding window function, and is specifically expressed as a rectangular window function with a length N of 64, a segment of the signal is selected for transformation starting from time point n and extending to each moment t, j denotes the imaginary unit, and f denotes a frequency.

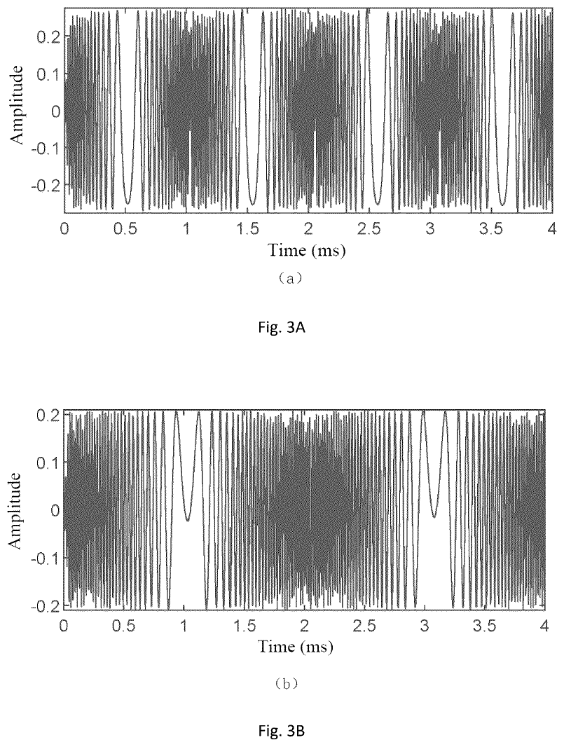

A radio frequency fingerprinting model is constructed, and the obtained spectrogram is inputted into the radio frequency fingerprinting model for training to obtain a trained radio frequency fingerprinting model, as shown in FIG. 2, including:
the convolutional layer includes a standardization layer, a point convolutional layer, a GLU activation function layer, a depthwise separable convolutional layer, a batch normalization layer, a Swish activation function layer, a concatenated convolutional layer, and a Dropout layer;
firstly, the obtained spectrogram is inputted into the convolutional layer, to standardize the inputted spectrogram to achieve a mean value of 0 and a variance of 1, thereby enhancing training stability, obtaining more uniformly distributed spectral features, and preserving a standardized output of an original structure; a channel dimension is adjusted by employing 1×1 convolutions through the point convolutional layer, feature information is fused or expanded, and a feature map with an adjusted number of channels is obtained; key information of the feature map is enhanced by the GLU activation function layer, while redundant information of the feature map is suppressed; parameters of the feature map are reduced by the depthwise separable convolutional layer, while a spatial feature is enhanced; the feature map with a stable distribution is obtained by the batch normalization layer; an activated feature map is obtained by the Swish activation function layer, while subtle gradient information of a negative value area is preserved; a final feature representation with an optimized number of channels is obtained through the concatenated convolutional layer; a regularized feature map X is obtained through the Dropout layer; and the module extracts low-level local features from the signal, such as edges and textures of the spectrogram, which contribute to subsequent pattern identification of the signal;
the regularized feature map is introduced into the positional encoding layer after being subjected to operations at the convolutional layer, to preserve time and sequence information, and obtain a feature map subjected to the positional encoding, an output of the convolutional layer is properly adjusted, a time relationship present in the data is captured, and specifically, positional embedding is added to the output of the convolutional layer, as shown in the following formula:

$$PE ( X ) = X + Embedding ( pos ) ,$$

where PE(X) denotes the feature map subjected to the positional encoding, X is the output of the convolutional layer, Embedding(pos) is positional encoding, the explicit encoding facilitates the model to understand an order and dependence of features in the sequence, which is a key factor for time series analysis and signal processing tasks;
finally, the feature map subjected to the positional encoding is inputted into the Transformer encoder, i.e., a stacked multi-module, and the Transformer encoder employs the multi-head self-attention mechanism to capture the global dependencies that span the entire sequence; and a long-distance relationship between the features is simulated, so that the model can understand a context and global mode that is critical for accurate classification, and specifically, operations are as follows:

$${head}_{i} = Attention ( {W}_{i}^{Q} {X}_{1} , {W}_{i}^{K} {X}_{1} , {W}_{i}^{V} {X}_{1} ) ;$$

where X₁ denotes an input, i.e., the feature map subjected to the positional encoding, and Wᵢ^{Q} denotes a query matrix of an i^{th} attention head, used for mapping an inputted feature to a query vector; Wᵢ^{K} denotes a key matrix of the i^{th} attention head, used for mapping the inputted feature to a key vector; Wᵢ^{V} denotes a value matrix of the i^{th} attention head, used for mapping the inputted feature to a value vector; and h attention heads generate a final output of the multi-head self-attention mechanism, and the output undergoes concatenation and linear transform, as shown in the following formula:

$$MHA ( {X}_{1} ) = {W}^{O} ( {head}_{1} ‖ … ‖ {head}_{h} ) ;$$

where MHA(X₁) denotes the output of the multi-head self-attention mechanism, and W^{O} is an output weight matrix; a combined output of the multi-head self-attention mechanism is mapped, to ensure alignment with a final output dimension of the Transformer model;
the attention mechanism enables the model to selectively focus on important features at different positions in the sequence, thereby more effectively simulating the global context and dependence; and the feed-forward neural network layer is employed to further complete the feature representation;
after the processing by the Transformer encoder, a time dimension of the feature map is compressed into a feature vector with a fixed length through a one-dimensional global average pooling layer; finally, the feature vector is fed into a fully connected layer and a Softmax layer for classification, and a trained RFF-CAT model, i.e., the radio frequency fingerprinting model, is obtained after training; the design of the RFF-CAT model ensures independent processing of local and global feature extraction; the convolutional layer specializes in capturing the local features, and the Transformer encoder is skilled in simulating the global dependence; by separating the tasks, the model reduces computation complexity, enhances flexibility, and improves performance in the noise environment; and compared with a traditional conformer model (generally integrating CNN and Transformer operations in a single module), the separation also results in a simpler and more interpretable model architecture; and
a training process of the RFF-CAT model includes:
   1) minimize a cross-entropy loss function by employing a root mean square propagation (RMSProp) optimization algorithm;
   2) perform batch processing on the training data, and execute multiple rounds of iterative training until convergence; and
   3) introduce a learning rate scheduling strategy in the training process to improve the training efficiency.

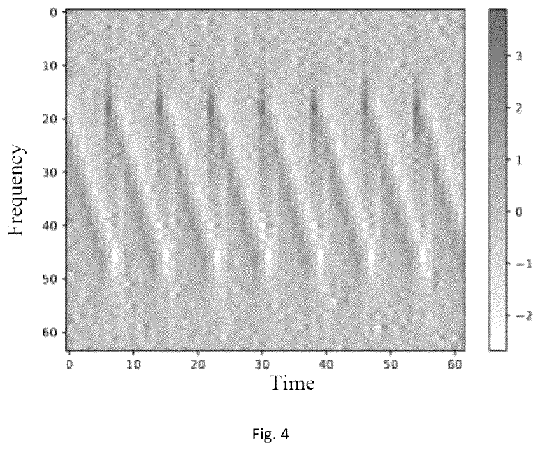

The step of performing prediction by employing the trained radio frequency fingerprinting model, to obtain a final prediction result by incorporating a multi-packet inference method includes:
first preprocess and transform radio frequency signal data from an unknown device into a channel-independent spectrogram at a prediction inference stage, as shown in FIG. 4, and then input the spectrogram into the trained RFF-CAT model, where an output of the Softmax layer in the RFF-CAT model is a probability vector, where each element represents a confidence level associated with one of the known devices, and the probability vector indicates the probability of the data packet belonging to each potential device, thereby achieving accurate and reliable device identification;
process an output of the RFF-CAT model by employing the multi-packet inference method, i.e., an adaptive multi-packet fusion method (MPF), to obtain a final output probability, where the multi-packet inference (MPF) method includes:
divide the inputted radio frequency signal data into a plurality of data packets, calculate an initial prediction value of each data packet, i.e., obtaining an initial prediction value through the RFF-CAT model, define an initial weight set, and then perform weighted summation, to obtain a fused prediction probability, as shown in the following formula:

$$p = \frac{1}{N} {\sum }_{n = 1}^{N} {w}_{n} {\hat{p}}_{n} ,$$

where p denotes the fused prediction probability, and \hat{p}ₙ denotes the prediction probability, i.e., the initial prediction value of an n^{th} data packet; wₙ denotes a weight of the prediction probability of the n^{th} data packet; and different contributions of different data packets may be quantized through the above formula, and different weights are set for the data packets; and
calculate an error between the initial prediction value and the fused prediction probability; and update the weight to adapt to the prediction value of each data packet, by generally following an update rule of an error-balancing algorithm, where at each iteration, the update rule of the weight is as shown in the following formula:

$${w}_{n + 1} = {w}_{n} + μ {e}_{n} {p}_{n} ,$$

where wₙ denotes a weight array of the prediction probability of the data packet with an index of n; wₙ₊₁ denotes the weight array of the data packet with the index of n after the weight is updated, which is prepared for a next iteration; μ denotes a learning rate, which controls an adjustment amplitude of the weight at each iteration; eₙ denotes the error between the initial prediction probability, i.e., the initial prediction value and the fused probability after weighted summation, which reflects a difference between the initial prediction probability and the prediction probability after the weighted summation; and pₙ is an array, including the initial prediction probabilities of the previous N data packets starting from index n.

Weighted summation is performed again on the prediction value of each data packet by employing the updated weight, to obtain a new fused prediction probability, i.e., identifying a radio frequency fingerprint of the corresponding device, where the model outputs the identity of the device, and further can distinguish different devices based on the uniqueness of the radio frequency signal, thereby achieving device authentication and identification.

After the training of the whole model is ended, the method further includes: signal samples of the unknown device are classified by employing the final trained model; accuracy, a recall rate, and an F1 value of the model are evaluated according to a classification result; and an evaluation result is stored, and the model is regularly updated to adapt to feature changes of new devices.

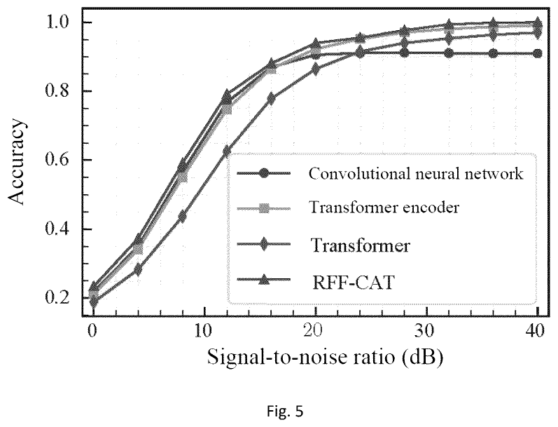

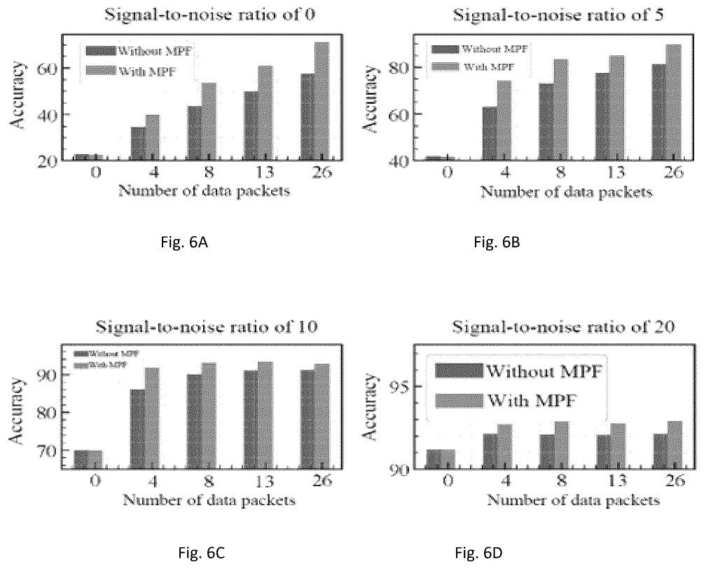

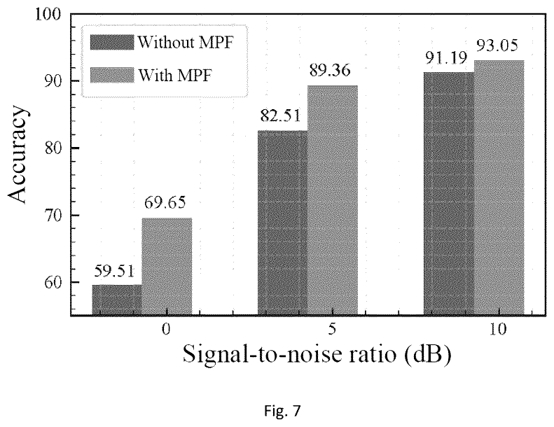

Results of radio frequency fingerprinting based on the convolutional neural network and the Transformer encoder and the multi-packet fusion method are as shown in FIG. 5, FIG. 6, and FIG. 7; FIG. 5 illustrates comparison of classification accuracy among the RFF-CAT model, the Transformer model, the convolutional neural network model, and the Transformer encoder model at different signal-to-noise ratio (SNR) levels, and the accuracy is all obtained without using the MPF method; and as shown in the drawings, at a low SNR level, the classification accuracy obtained employing the RFF-CAT model is approximately 10% higher than that obtained employing the Transformer model. At a high signal-to-noise ratio level, the classification accuracy obtained employing the RFF-CAT model is approximately 4% to 5% higher than that obtained employing the Transformer model. Furthermore, the overall classification accuracy obtained employing the RFF-CAT model is approximately 10% higher than that obtained employing the Transformer model. The RFF-CAT utilizes a convolution operation to capture a local mode and features, which is particularly useful at the low signal-to-noise ratio level. By using the proposed RFF-CAT training model for simulation, an obtained experimental result shows that the model has excellent performance. FIG. 6(a) is a schematic diagram showing accuracy with and without MPF at a signal-to-noise ratio of 0; FIG. 6(b) is a schematic diagram showing the accuracy with and without the MPF at a signal-to-noise ratio of 5; FIG. 6(c) is a schematic diagram showing the accuracy with and without the MPF at a signal-to-noise ratio of 10; and FIG. 6(d) is a schematic diagram showing the accuracy with and without the MPF at a signal-to-noise ratio of 20. It may be seen from FIG. 6 and FIG. 7 that the MPF method of the present disclosure can significantly improve the RFF performance, especially in a low signal-to-noise ratio scene.

### Embodiment 3

A computer device is provided, which includes a memory and a processor, where the memory has a computer program stored therein, and the processor, when executing the computer program, implements the steps of the radio frequency fingerprinting method based on the convolution-attention mechanism and multi-packet inference as described in Embodiment 1 or 2.

### Example 4

A computer-readable storage medium is provided, which has a computer program stored therein, where the computer program is executed by a processor to implement the steps of the radio frequency fingerprinting method based on the convolution-attention mechanism and multi-packet inference as described in Embodiment 1 or 2.

### Example 5

A preprocessing module is configured to capture a device transmission signal, and preprocess the transmission signal to obtain a spectrogram;
a model training module is configured to construct a radio frequency fingerprinting model, and input the obtained spectrogram into the radio frequency fingerprinting model for training, to obtain a trained radio frequency fingerprinting model;
the radio frequency fingerprinting model includes a convolutional layer, a positional encoding layer and a Transformer encoder;
the convolutional layer transforms an inputted feature map into a high-order feature representation;
the positional encoding layer is configured to add position information;
the Transformer encoder includes a multi-head self-attention mechanism and a feed-forward neural network layer, the multi-head self-attention mechanism is used for capturing global dependencies that span an entire sequence, and the feed-forward neural network layer further enhances a feature expression capability; and
a multi-packet inference module is configured to perform prediction by employing the trained radio frequency fingerprinting model, to obtain a final prediction result by integrating a multi-packet inference method.

What is claimed is:

1. A radio frequency fingerprinting method based on a convolution-attention mechanism and multi-packet inference, comprising:
step 1: capturing a device transmission signal, and preprocessing the transmission signal to obtain a spectrogram;
step 2: constructing a radio frequency fingerprinting model, and inputting the obtained spectrogram into the radio frequency fingerprinting model for training, to obtain a trained radio frequency fingerprinting model, wherein
the radio frequency fingerprinting model comprises a convolutional layer, a positional encoding layer, and a Transformer encoder;
the convolutional layer transforms an inputted feature map into a high-order feature representation;
the positional encoding layer is configured to add position information;
the Transformer encoder comprises a multi-head self-attention mechanism and a feed-forward neural network layer, the multi-head self-attention mechanism is used for capturing global dependencies that span an entire sequence, and the feed-forward neural network layer further enhances a feature representation capability;
the convolutional layer comprises a standardization layer, a point convolutional layer, a GLU activation function layer, a depthwise separable convolutional layer, a batch normalization layer, a Swish activation function layer, a concatenated convolutional layer, and a Dropout layer;
firstly, the obtained spectrogram is inputted into the convolutional layer, to standardize the inputted spectrogram; a channel dimension is adjusted by employing 1×1 convolutions through the point convolutional layer, to obtain a feature map with an adjusted number of channels; key information of the feature map is enhanced through the GLU activation function layer while redundant information of the feature map is suppressed; parameters of the feature map are reduced through the depthwise separable convolutional layer while a spatial feature is enhanced; a feature map with a stable distribution is obtained through the batch normalization layer; an activated feature map is obtained through the Swish activation function layer while subtle gradient information of a negative value region is preserved; a final feature representation with an optimized number of channels is obtained through the concatenated convolutional layer; and finally a regularized feature map X is obtained through the Dropout layer;
then, the regularized feature map is introduced into the positional encoding layer after being subjected to the operations at the convolutional layer, to obtain a feature map subjected to positional encoding, and a time relationship present in the data is captured;
finally, the feature map subjected to positional encoding is inputted into the Transformer encoder, and the Transformer encoder captures the global dependencies that span the entire sequence by employing the multi-head self-attention mechanism; and
after the processing by the Transformer encoder, a time dimension of the feature map is compressed into a feature vector with a fixed length through a one-dimensional global average pooling layer; and finally, the feature vector is fed into a fully connected layer and a Softmax layer for classification, and a trained RFF-CAT model, i.e., the radio frequency fingerprinting model, is obtained after training; and
step 3: performing prediction by employing the trained radio frequency fingerprinting model, to obtain a final prediction result by incorporating a multi-packet inference method, wherein
the multi-packet inference method comprises:
dividing inputted radio frequency signal data into a plurality of data packets, calculating an initial prediction value of each data packet, i.e., obtaining an initial prediction value through the RFF-CAT model, defining an initial weight set, and then performing weighted summation, to obtain a fused prediction probability;
calculating an error between the initial prediction value and the fused prediction probability, and updating a weight to adapt to the prediction value of each data packet; and
performing weighted summation again on the prediction value of each data packet by employing the updated weight, to obtain a new fused prediction probability, i.e., identifying a radio frequency fingerprint of a corresponding device, to achieve device authentication and identification.

2. The radio frequency fingerprinting method based on a convolution-attention mechanism and multi-packet inference according to claim 1, wherein the capturing a device transmission signal, and preprocessing the transmission signal to obtain a spectrogram comprises:
firstly, acquiring the transmission signal from a long range (LoRa) device, and denoting the acquired transmission signal as r(n), the LoRa device employing a LoRa protocol;
secondly, calculating a carrier frequency offset, as shown in the following formula;
$$Δ f = \frac{1}{2 π} \frac{d}{dt} arg ( r ( n ) ) ,$$
wherein arg(⋅) denotes a phase of the transmission signal, n denotes a time variable, and Δf denotes the carrier frequency offset;
compensating the carrier frequency offset, as shown in the following formula;
$$\hat{r} ( n ) = r ( n ) \cdot {e}^{- j \cdot 2 π \cdot CFO \cdot t} ,$$
wherein r(n) is a received signal, \hat{r}(n) is a compensated signal, j denotes an imaginary unit, CFO denotes the carrier frequency offset, i.e., Δf, and t denotes the time variable;
normalizing the compensated signal into a unit amplitude by employing data normalization, as shown in the following formula:
$${T}_{norm} ( n ) = \frac{\hat{r} ( n )}{max ( \vert \hat{r} ( n ) \vert )} ,$$
wherein rₙₒᵣₘ(n) denotes the normalized received signal; and
finally, performing short-time Fourier transform (STFT) to covert the signal into a channel-independent spectrogram, as shown in the following formula:
$$S ( f , t ) = {\sum }_{n = 0}^{N - 1} {r}_{norm} ( n ) \cdot w ( n - t ) \cdot {e}^{- j 2 π fn} ,$$
wherein S(f, t) denotes the spectrogram, w(n−t) denotes a matrix window with a length of N, and a segment of the signal is selected for transformation starting from time point n and extending to each moment t, j denotes the imaginary unit, and f denotes a frequency.

3. The radio frequency fingerprinting method based on a convolution-attention mechanism and multi-packet inference according to claim 2, wherein the constructing a radio frequency fingerprinting model, and inputting the obtained spectrogram into the radio frequency fingerprinting model for training, to obtain a trained radio frequency fingerprinting model comprises:
introducing the feature map into the positional encoding layer after being subjected to the operations at the convolutional layer, to obtain the feature map subjected to positional encoding, and capturing the time relationship present in the data, a formula being as follows:
$$PE ( X ) = X + Embedding ( pos ) ,$$
wherein PE(X) denotes the feature map subjected to the positional encoding, X denotes an output of the convolutional layer, and Embedding(pos) denotes positional encoding; and
inputting the feature map subjected to positional encoding into the Transformer encoder, an operation being as follows:
$${head}_{i} = Attention ( {W}_{i}^{Q} {X}_{1} , {W}_{i}^{K} {X}_{1} , {W}_{i}^{V} {X}_{1} ) ;$$
wherein X₁ denotes an input, i.e., the feature map subjected to positional encoding, and Wᵢ^{Q} denotes a query matrix of an i^{th} attention head; Wᵢ^{K} denotes a key matrix of the i^{th} attention head; Wᵢ^{V} denotes a value matrix of the i^{th} attention head; h attention heads generate a final output of the multi-head self-attention mechanism, and the output undergoes concatenation and linear transform, as shown in the following formula:
$$MHA ( {X}_{1} ) = {W}^{O} ( {head}_{1} ‖ … ‖ {head}_{h} ) ;$$
wherein MHA(X₁) denotes the output of the multi-head self-attention mechanism, and W^{O} is an output weight matrix; a combined output of the multi-head self-attention mechanism is mapped, and the feed-forward neural network layer is employed to further complete the feature representation.

4. The radio frequency fingerprinting method based on a convolution-attention mechanism and multi-packet inference according to claim 3, wherein the performing prediction by employing the trained radio frequency fingerprinting model, to obtain a final prediction result by incorporating a multi-packet inference method comprises:
first preprocessing and transforming radio frequency signal data from an unknown device into a channel-independent spectrogram at a prediction inference stage, and then inputting the spectrogram into the trained RFF-CAT model;
processing an output of the RFF-CAT model by the multi-packet inference method, i.e., an adaptive fusion method, to obtain a final output probability;
the fused prediction probability is as follows:
$$p = \frac{1}{N} {\sum }_{n = 1}^{N} {w}_{n} {\hat{p}}_{n} ,$$
wherein p denotes the fused prediction probability, [symbol] ₙ denotes the prediction probability, i.e., the initial prediction value, of an n^{th} data packet, and wₙ denotes a weight of the prediction probability of the n^{th} data packet; and
an update rule of the weight at each iteration is as shown in the following formula:
$${w}_{n + 1} = {w}_{n} + μ {e}_{n} {p}_{n} ,$$
wherein wₙ denotes a weight array of the prediction probability of the data packet with an index of n; wₙ₊₁ denotes the weight array of the data packet with the index n after the weight is updated; μ denotes a learning rate, used for controlling an adjustment amplitude of the weight at each iteration; eₙ denotes the error between the initial prediction probability, i.e., the initial prediction value, and the fused probability after weighted summation; and pₙ is an array, including the initial prediction probabilities of the previous N data packets starting from the index n.

5. The radio frequency fingerprinting method based on a convolution-attention mechanism and multi-packet inference according to claim 1, wherein a computer device, comprising a memory and a processor, wherein the memory has a computer program stored therein, and the processor, when executing the computer program, implements steps of the radio frequency fingerprinting method based on the convolution-attention mechanism and multi-packet inference.

6. The radio frequency fingerprinting method based on a convolution-attention mechanism and multi-packet inference according to claim 1, wherein a computer-readable storage medium, having a computer program stored therein, wherein the computer program, when executed by a processor, implements steps of the radio frequency fingerprinting method based on the convolution-attention mechanism and multi-packet inference.

7. A radio frequency fingerprinting system based on a convolution-attention mechanism and multi-packet inference, comprising:
a preprocessing module, configured to capture a device transmission signal, and preprocess the transmission signal to obtain a spectrogram;
a model training module, configured to construct a radio frequency fingerprinting model, and input the obtained spectrogram into the radio frequency fingerprinting model for training, to obtain a trained radio frequency fingerprinting model, wherein
the radio frequency fingerprinting model comprises a convolutional layer, a positional encoding layer, and a Transformer encoder;
the convolutional layer transforms an inputted feature map into a high-order feature representation;
the positional encoding layer is configured to add position information;
the Transformer encoder comprises a multi-head self-attention mechanism and a feed-forward neural network layer, the multi-head self-attention mechanism is used for capturing global dependencies that span an entire sequence, and the feed-forward neural network layer further enhances a feature representation capability;
the convolutional layer comprises a standardization layer, a point convolutional layer, a GLU activation function layer, a depthwise separable convolutional layer, a batch normalization layer, a Swish activation function layer, a concatenated convolutional layer, and a Dropout layer;
firstly, the obtained spectrogram is inputted into the convolutional layer, to standardize the inputted spectrogram; a channel dimension is adjusted by employing 1×1 convolutions through the point convolutional layer, to obtain a feature map with an adjusted number of channels; key information of the feature map is enhanced through the GLU activation function layer while redundant information of the feature map is suppressed; parameters of the feature map are reduced through the depthwise separable convolutional layer while a spatial feature is enhanced; a feature map with a stable distribution is obtained through the batch normalization layer; an activated feature map is obtained through the Swish activation function layer while subtle gradient information of a negative value region is preserved; a final feature representation with an optimized number of channels is obtained through the concatenated convolutional layer; and finally, a regularized feature map X is obtained through the Dropout layer;
then, the feature map is introduced into the positional encoding layer after being subjected to operations at the convolutional layer, to obtain a feature map subjected to positional encoding, and a time relationship present in the data is captured;
finally, the feature map subjected to positional encoding is inputted into the Transformer encoder, and the global dependencies that span the entire sequence are captured through the Transformer encoder by employing the multi-head self-attention mechanism; and
after the processing by the Transformer encoder, a time dimension of the feature map is compressed into a feature vector with a fixed length through a one-dimensional global average pooling layer; and finally the feature vector is fed into a fully connected layer and a Softmax layer for classification, and the trained RFF-CAT model, i.e., the radio frequency fingerprinting model, is obtained after training; and
a multi-packet inference module, configured to perform prediction by employing the trained radio frequency fingerprinting model, to obtain a final prediction result by incorporating a multi-packet inference method, wherein
the multi-packet inference method comprises:
dividing inputted radio frequency signal data into a plurality of data packets, calculating an initial prediction value of each data packet, i.e., obtaining an initial prediction value through the RFF-CAT model, defining an initial weight set, and then performing weighted summation, to obtain a fused prediction probability;
calculating an error between the initial prediction value and the fused prediction probability, and updating a weight to adapt to the prediction value of each data packet; and
performing weighted summation again on the prediction value of each data packet by employing the updated weight, to obtain a new fused prediction probability, i.e., identifying a radio frequency fingerprint of a corresponding device, to achieve device authentication and identification.
